(19) United States
(12) Patent Application Publication
(10) Pub. No.: US 2011/0318083 A1
(43) Pub. Date: Dec. 29, 2011

(54) WRITING IMPLEMENT WITH A RETRACTABLE CLIP

(75) Inventor: Hyun-Son Yoon, Incheon (KR)

(73) Assignee: MORRIS CORPORATION, Incheon-shi (KR)

(21) Appl. No.: 13/255,482

(22) PCT Filed: Mar. 9, 2010
(86) PCT No.: PCT/KR10/01452

§ 371 Date: Sep. 8, 2011

(30) Foreign Application Priority Data
Mar. 9, 2009 (KR) 10-2009-0019792

(51) Int. Cl. B43K 24/02; B43K 25/02

(52) U.S. Cl. 401/106; 401/131; 401/99

(57) ABSTRACT

The present invention relates to a writing implement with a retractable clip in which a clip is configured to be retractable into a pen body, so that the clip can be kept in a retracted state when the clip is not being used and, therefore, the clip is not easily broken and does not easily injure a user and, furthermore, allows the user to efficiently use a space for receiving writing implements.

### TECHNICAL FIELD

The present invention relates, in general, to a writing implement having a clip capable of clipping the writing implement onto paper or fabric material and, more particularly, to a writing implement with a retractable clip, in which the clip is configured to be retractable into a pen body so that the clip can be retracted into the pen body to write with the writing implement.

### BACKGROUND ART

Generally, writing implements may not be stored easily or safely, and are required to be placed within user's reach such that the user can easily use it at any time and at any place and, accordingly, the writing implement may be provided with a clip on a predetermined portion thereof such that the writing implement can be clipped onto an easily reachable portion of paper or fabric material.

However, as shown in FIG. 1, the conventional clip 20 of a writing implement 10 typically protrudes to form a sharp shape so that the clip may injure a user or break easily. Further, the clip easily comes into contact with a user's hand when taking notes so that the clip may disturb a user while writing.

### DISCLOSURE

### Technical Problem

Accordingly, the present invention has been made keeping in mind the above problems occurring in the related art, and is intended to provide a writing implement with a retractable clip, in which a clip is configured to be retractable into a pen body of the writing implement so that the clip can be retracted into the pen body when writing with the writing implement.

### Technical Solution

In an aspect, the present invention provides a writing implement with a retractable clip, including: a lower barrel retractably receiving a spring-biased cartridge therein; a middle joint fastened at a second end thereof to the lower barrel by a screw-type fastening; a cam having a guide protrusion at an end thereof so as to be rotated and axially moved along a thread formed on an inner surface of the middle joint; an upper barrel receiving the cam therein and rotatably coupled at a first end thereof to the middle joint; and a clip ejected from and retracted into both the upper barrel and the cam.

Further, in the present invention, when the lower barrel is rotated in a state in which the cartridge is retracted into the lower barrel and the clip is ejected from both the upper barrel and the cam, the middle joint may be rotated along with the lower barrel and the guide protrusion of the cam engaged with the thread of the middle joint may move downwards along the thread by the rotation of the middle joint so that the clip engaged with the cam can slide to be retracted into the cam.

Further, in the present invention, the lower barrel may include: a thread formed on an inner surface of a first end of the lower barrel so that the middle joint can be fastened to the lower barrel; and a cartridge ejecting hole formed in a second end of the lower barrel such that the cartridge can be ejected and retracted through the cartridge ejecting hole.

Further, in the present invention, the middle joint may include: a lower barrel fastening thread having a size corresponding to a diameter of the lower barrel so as to be inserted into a first end of the lower barrel, the lower barrel fastening thread being formed on an outer surface of a lower part of the middle joint and fastened to an inner thread of the lower barrel; an upper barrel fastening groove having an annular shape formed in the middle joint at a location spaced apart from the lower barrel fastening thread by a predetermined distance, and engaged with an annular protrusion of the upper barrel such that the upper barrel can be rotatably fastened to the groove; a stop protrusion axially protruding from an annular upper end surface of the middle joint in such a way that the stop protrusion extends from inner and outer surfaces of the middle joint; a stopper axially protruding from the annular upper end surface in such a way that the stopper extends from the inner surface of the middle joint and has a thickness smaller than a thickness of the stop protrusion; and the thread formed on the inner surface of the middle joint so as to be engaged with the guide protrusion of the cam in such a way that the guide protrusion can move along the thread.

Further, in the present invention, the cam may include: a clip receiving opening formed in an upper portion of the cam and receiving the clip therein; a plurality of inclined rails formed on opposite inner surfaces of the clip receiving opening and engaged with respective inclined grooves of the clip; and an upper barrel bar seat having a cylindrical shape, with L-shaped cutouts formed in opposite sides of a circumferential surface of the upper barrel bar seat in such a way that the upper barrel can be stopped by the cutouts so that, even when the middle joint is rotated, the cam can be prevented from rotating.

Further, in the present invention, the upper barrel may include: a clip ejecting opening having a long elliptical shape formed in a side surface of the upper barrel and allowing the clip to be ejected from and retracted into the upper barrel; a projection formed in an upper portion of the clip ejecting opening and engaged with a guide line groove of the clip; a middle joint fastening protrusion having an annular shape formed on an inner surface of a lower part of the upper barrel and rotatably engaged with the middle joint; a step formed in a portion of the upper barrel spaced apart from the middle joint fastening protrusion by a predetermined distance and providing a space for allowing both a stopper and a stop protrusion of the middle joint to move; and a pair of cam locking bars axially formed in a sidewall of the upper barrel.

Further, in the present invention, the upper barrel may be provided with an anti-rolling protrusion on a predetermined portion of an outer circumferential surface thereof.

Further, in the present invention, the clip may include: a linear guide line groove formed in an upper portion of a side surface of the clip in such a way that the guide line groove extends in a direction perpendicular to a cartridge moving direction; and a plurality of inclined grooves formed in opposite side surfaces of the clip at locations beneath and spaced apart from the guide line groove by a predetermined distance and engaged with respective inclined rails of the cam.

### Advantageous Effects

As described above, a writing implement with a retractable clip according to the present invention is advantageous because a clip can be kept in a retracted state when the clip is not being used because the clip is configured to be retractable into a pen body, so that the clip is free from being easily broken or easily injuring a user and, furthermore, allows the user to efficiently use a space for receiving writing implements.

Further, when the writing implement is used to write with, the clip can stay in the retracted state, thus improving the feeling of gripping the writing implement.

### DESCRIPTION OF DRAWINGS

FIG. 1 is a view of a conventional writing implement with a clip;

FIG. 2 is an exploded perspective view of a writing implement with a retractable clip according to an embodiment of the present invention;

FIG. 3 is a perspective view and a side view showing a lower barrel according to the embodiment of the present invention;

FIG. 4 is a perspective view and a sectional view showing a middle joint according to the embodiment of the present invention;

FIG. 5 is a perspective view and a side view showing a cam according to the embodiment of the present invention;

FIG. 6 is a perspective view, a side view and a sectional view showing an upper barrel according to the embodiment of the present invention;

FIG. 7 is a perspective view and a side view showing a clip according to the embodiment of the present invention;

FIG. 8 is a perspective view of an assembled writing implement with a retractable clip according to the embodiment of the present invention, from which the upper and lower barrels are omitted;

FIG. 9 is a sectional view showing a writing implement with a retractable clip according to the embodiment of the present invention in a state in which a cartridge has been retracted; and

FIG. 10 is a sectional view showing a writing implement with a retractable clip according to the embodiment of the present invention in a state in which the cartridge has been elected.

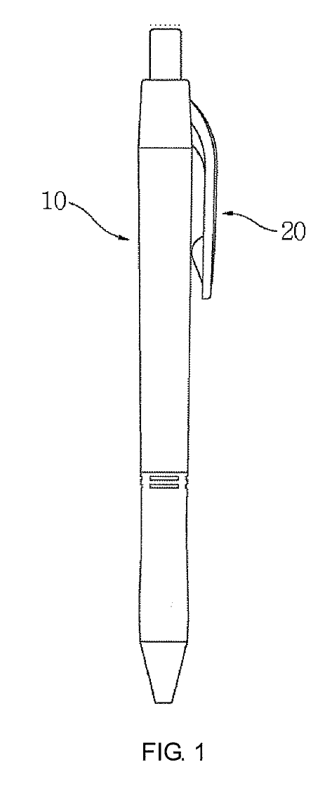

* Description of reference numbers of important parts*

| | |
|---|---|
| 200: a cam | 300: a middle joint |
| 400: a lower barrel | 500: an upper barrel |
| 600: a clip | |

### BEST MODE

Hereinbelow, an embodiment of a writing implement with a retractable clip according to the present invention will be described in detail with reference to the accompanying drawings.

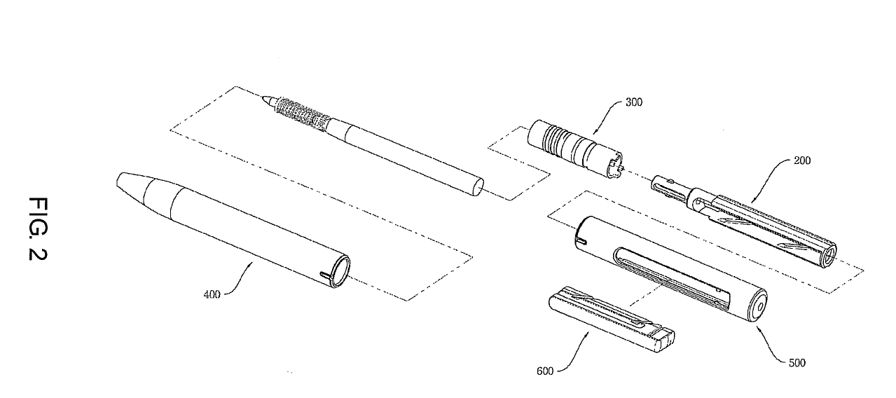

FIG. 2 is an exploded perspective view of a writing implement with a retractable clip according to the embodiment of the present invention. As shown in the drawing, the writing implement with a retractable clip includes a lower barrel 400 retractably receiving a spring-biased cartridge therein, a middle joint 300 fastened at a second end thereof to the lower barrel 400 by a screw-type fastening, a cam 200 having a guide protrusion at an end thereof so as to be rotated and axially moved along a thread formed on the inner surface of the middle joint 300, an upper barrel 500 receiving the cam 200 therein and rotatably coupled to the middle joint 300 at a first end thereof, and a clip 600 ejected from and retracted into both the upper barrel 500 and the cam 200.

Further, it is preferred that the elements of the present invention be provided with a pair of protrusions, a pair of steps corresponding to the protrusions, and a pair of grooves or a pair of threads on the inner and outer surfaces thereof in an effort to realize stronger engagement of the elements and to more effectively distribute the actuating force over the elements.

Further, in the following description of the embodiment of the present invention, the end having a cartridge ejecting hole, toward which a cartridge is moved to be ejected, will be referred to as the lower end, and the end having the clip, toward which the cartridge is moved to be retracted, will be referred to as the upper end, and in the operation of the writing implement, the direction toward the cartridge ejecting hole will be referred to as the forward or upward direction, and the direction toward the clip will be referred to as the retracted, rearward or downward direction.

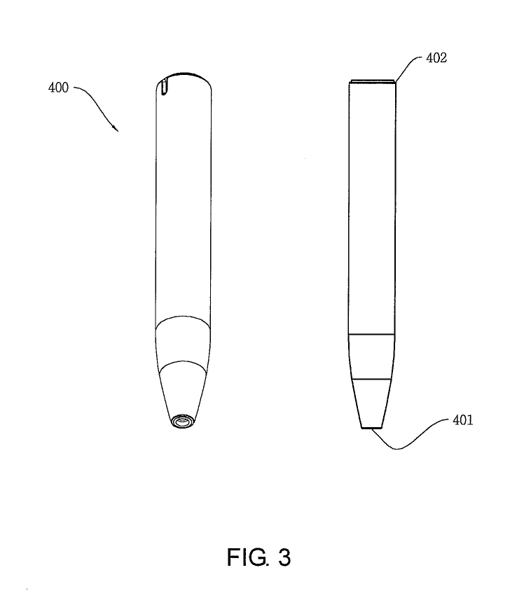

FIG. 3 is a perspective view and a side view showing a lower barrel according to the embodiment of the present invention.

The lower barrel 400 has a thread 402 on an inner surface of a first end thereof to fasten it to the middle joint 300 as will be described later herein.

The lower barrel 400 receives a spring therein and a cartridge is inserted into the lower barrel 400 from the first end of the lower barrel such that the cartridge passes through the spring and can be elastically ejected and retracted through a cartridge ejecting hole 401 formed in a second end of the lower barrel.

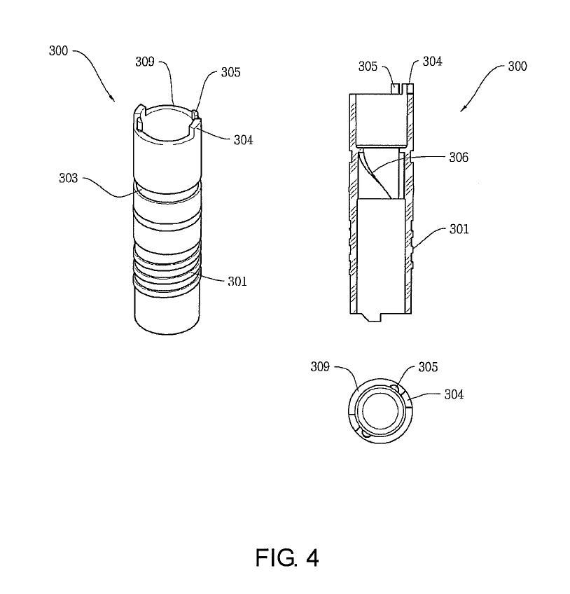

FIG. 4 is a perspective view and a sectional view showing a middle joint according to the embodiment of the present invention.

The middle joint 300 has a hollow tubular shape with a size corresponding to a diameter of the lower barrel 400 so that it can be inserted into the first end of the lower barrel 400.

The middle joint 300 has a lower barrel fastening thread 301 formed around an outer surface of a lower end of the middle joint and is fastened to the internal thread 402 of the lower barrel 400.

Further, the middle joint 300 has an upper barrel fastening groove 303 which has an annular shape and functions to rotatably fasten the upper barrel 500 as will be described later herein.

That is, the upper barrel fastening groove 303 having the annular shape is formed in the middle joint 300 at a location spaced apart from the lower barrel fastening thread 301 by a predetermined distance. The groove 303 is engaged with an annular protrusion 507 of the upper barrel 500 which will be described later herein so that the upper barrel 500 can be rotatably fastened to the middle joint 300 in such a way that the upper barrel is only rotatable relative to the middle joint without being axially moved.

Both a stop protrusion 304 and a stopper 305 which is thinner than the stop protrusion 304 axially protrude from an annular upper end surface 309 of the middle joint 300.

As shown in the sectional view, on the annular upper end surface 309, the stop protrusion 304 axially extends from the inner and outer surfaces of the middle joint and the stopper 305 axially extends from the inner surface of the middle joint.

In other words, although both the stopper and the stop protrusion axially extend from the inner surface of the middle joint 300 at respective locations on the upper end surface 309, the stopper 305 is thinner than the stop protrusion 304. Therefore, when the lower end 504 of a cam locking bar 503 of the upper barrel which will be described later herein moves on the annular upper end surface 309, the lower end 504 can be passed over the stopper 305 by a rotating force applied thereto. However, in the above state, the lower end 504 of the cam locking bar cannot pass over the stop protrusion 304, but is stopped by the stop protrusion 304, so that the lower end of the cam locking bar will be retained in a place between the stop protrusion 304 and the stopper 305 without rotating until the lower end of the cam locking bar is rotated in an opposed direction.

Further, a thread 306 is formed in the inner surface of the middle joint 300 so as to be movably engaged with a guide protrusion 202 of the cam as will be described later herein.

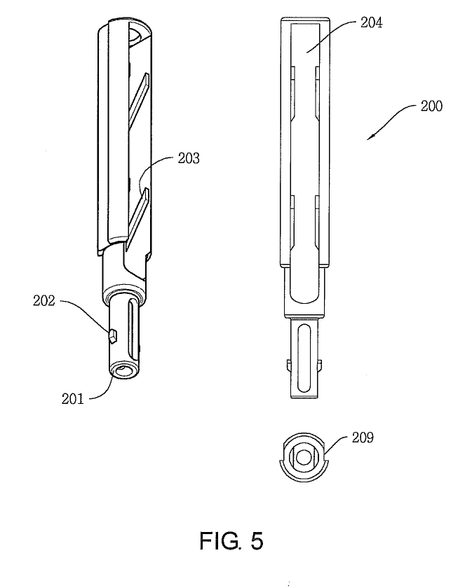

FIG. 5 is a perspective view and a side view showing a cam according to the embodiment of the present invention.

The cam 200 has a size which is allowed to be inserted into the middle joint 300 at a lower part thereof and is allowed to be inserted into the upper barrel 500 at an upper end thereof. Further, two guide protrusions 202 are formed in opposite surfaces of the cam at predetermined locations in a lower portion.

The guide protrusions 202 come into movable contact with a slope surface of the thread 306 formed in the inner surface of the middle joint 300 so that the guide protrusions can move along the thread 306.

In the upper portion of the cam 200, a clip receiving opening 204 is formed to receive the clip 600 therein as will be described later herein.

Further, a plurality of inclined rails 203 are formed in opposite inner surfaces of the clip receiving opening 204 and are engaged with respective inclined grooves 602 of the clip 600 which will be described later herein.

The lower end 201 of the cam 200 is in contact with the upper end of the cartridge and the upper end of the cam is in contact with the upper inner end of the upper barrel.

As shown in the sectional view, the cam 200 further has an upper barrel bar seat 209 that has a cylindrical shape, with L-shaped cutouts formed in opposite sides of the circumferential surface of the upper barrel bar seat 209.

Therefore, the cam locking bar 503 of the upper barrel 500 can be stopped by the cutouts of the upper barrel bar seat 209 so that, even when the middle joint 300 is rotated, the cam 200 can be prevented from rotating.

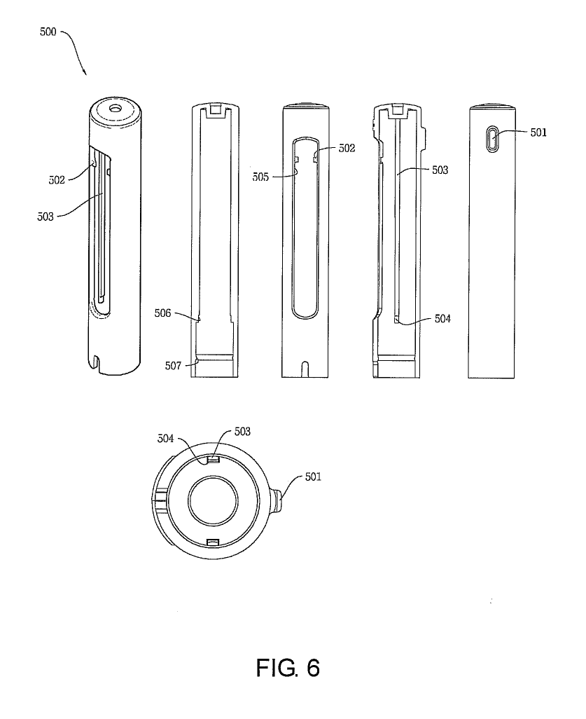

FIG. 6 is a perspective view, a side view and a sectional view showing an upper barrel according to the embodiment of the present invention.

The upper barrel 500 has a cylindrical structure which is open in one end thereof, with a long elliptical clip ejecting opening 505 formed in a sidewall of the upper barrel through which the clip 600 can be ejected and retracted.

In the upper portion of the clip ejecting opening 505, a projection 502 is formed to be engaged with a guide line groove 601 of the clip 600 which will be described later herein.

To allow the upper barrel 500 to be rotatably fastened to the middle joint 300, a middle joint fastening protrusion 507 having an annular shape is formed on the inner surface of the lower portion of the upper barrel.

Further, the upper barrel 500 has a step 506 at a location spaced apart from the middle joint fastening protrusion 507 by a predetermined distance, thus providing a space for allowing both the stopper 305 and the stop protrusion 304 of the middle joint 300 to move.

Further, a pair of cam locking bars 503 are axially formed in the inner surface of the upper barrel 500. Here, the lower end 504 of each cam locking bar 503 is configured to pass over the stopper 305 of the middle joint 300.

An anti-rolling protrusion 501 is formed on the outer circumferential surface of the upper barrel 500 at a predetermined location, so that even when the writing implement rolls on a surface in a state in which the clip 600 is in a retracted state, the anti-rolling protrusion can stop the writing implement from rolling.

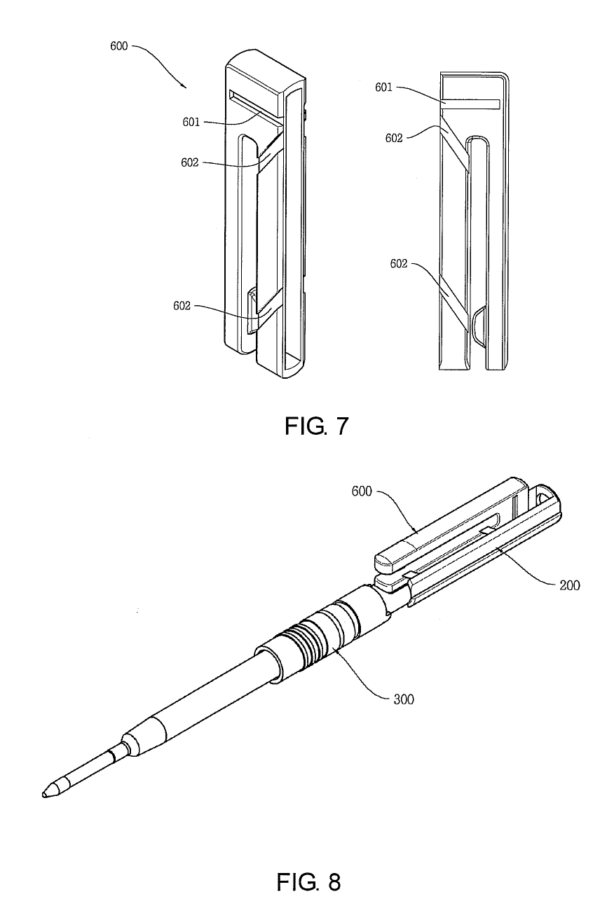

FIG. 7 is a perspective view and a side view showing a clip according to the embodiment of the present invention.

The clip 600 is received in the clip receiving opening 204 of the cam 200 received in the upper barrel 500. In the above state, the clip 600 is inserted into the upper barrel 500 through the clip ejecting opening 505 and is, thereafter, received in the clip receiving opening 204 of the cam 200.

The clip 600 has a shape corresponding to the shape of the clip ejecting opening 505 of the upper barrel 500 and the side surfaces of the clip 600 are configured to form flat surfaces capable of being axially moved.

Particularly, a linear guide line groove 601 is formed in the upper portion of each of the side surfaces of the clip 600 in a direction perpendicular to a cartridge moving direction. The clip 600 can be moved in a radial direction along a path formed by the linear guide line groove 601.

Further, the clip 600 has a plurality of inclined grooves 602 which are formed in opposite side surfaces of the clip at locations spaced beneath and apart from the guide line groove 601 by a predetermined distance. The inclined grooves 602 are engaged with the respective inclined rails 203 of the cam 200.

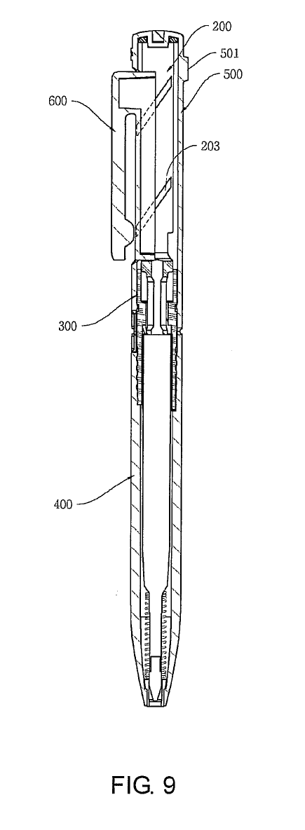

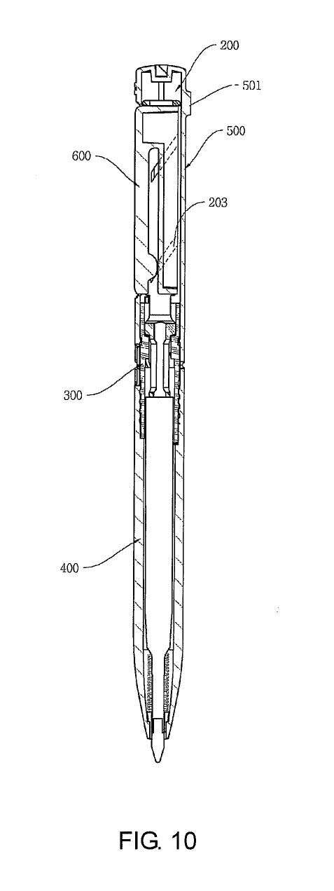

FIG. 8 is a perspective view of a assembled writing implement with a retractable clip according to the embodiment of the present invention, from which the upper and lower barrels are omitted. FIG. 9 is a sectional view showing a writing implement with a retractable clip according to the embodiment of the present invention in a state in which a cartridge has been retracted. FIG. 10 is a sectional view showing a writing implement with a retractable clip according to the embodiment of the present invention in a state in which the cartridge has been ejected.

First, a cartridge with a spring fitted over the cartridge is inserted into the end of the lower barrel 400.

Here, the middle joint 300 has been assembled with the cam 200. In the above state, the guide protrusions 202 of the cam are in contact with the slope surface of the thread 306 formed in the inner surface of the middle joint in such a way that the guide protrusions 202 are movable only along the thread 306 so that the lower portion of the cam 200 cannot be removed from the middle joint 300.

Thereafter, the lower barrel 400 having the cartridge therein is fastened to the middle joint 300 by a screw-type fastening, so that the spring biases the cartridge from the lower end of the lower barrel and the lower end of the cam 200 restrained in the middle joint 300 comes into contact with the upper end of the cartridge. In the above state, due to the restoring force of the spring, both the cartridge and the cam 200 are retained in an upward biased state.

Thereafter, the cam 200 is inserted into the upper barrel 500 in such a way that the cam locking bars 503 of the upper barrel 500 are seated in the respective cutouts of the upper barrel bar seat 209 of the cam 200.

Further, the middle joint fastening protrusion 507 of the upper barrel 500 is engaged with the upper barrel fastening groove 303 of the middle joint 300 in such a way that the upper barrel 500 can be rotatably fastened to the middle joint 300. Therefore, the cam locking bars 503 are seated in the cutouts of the upper barrel bar seat 209, and the clip receiving opening 204 of the cam 200 and the clip ejecting opening 505 of the upper barrel 500 are aligned with each other.

In the state in which the clip receiving opening 204 and the clip ejecting opening 505 are aligned with each other, the clip 600 is inserted into the clip ejecting opening 505, so that the inclined rails 203 are engaged with the inclined grooves 602 and the projection 502 of the upper barrel 500 is seated in the guide line groove 601 of the clip 600. Therefore, the clip 600 is located in an ejected state in the upper barrel 500.

When the lower barrel 300 is rotated relative to the upper barrel 500 which is fixed in the state in which the cartridge is in a retracted state as shown in FIG. 8 and FIG. 9, the lower barrel 400 and the middle joint 300 fastened to the lower barrel are rotated at the same time. Therefore, the guide protrusions 202 of the cam 200 which are movably engaged with the thread 306 of the middle joint 300 are rotated downwards along the thread 306 due to the rotation of the middle joint 300.

In the above state, the cutouts of the upper barrel bar seat 209 of the cam 200 prevent the cam locking bars 503 of the upper barrel 500 from being rotated, so that the upper barrel 500 can be moved in axial directions without rotating.

Here, because the cam 200 is moved downwards by the guide protrusions 202, the inclined grooves 602 of the clip 600 engaged with the inclined rails 203 of the cam 200 slide along the inclined rails 203 and, at the same time, the guide line groove 601 of the clip engaged with the projection 502 of the upper barrel is linearly moved under the guide of the projection 502.

In other words, when the cam 200 is axially moved downwards, the clip 600 is moved in a direction perpendicular to the cartridge moving direction along both the projection 502 and the inclined rails 203, thus being retracted into the clip receiving opening 204 of the cam 200.

When a stronger rotating force is applied to the lower barrel 400 in the above state, the stopper 305 of the middle joint 300 comes into contact with the lower end 504 of the upper barrel 500 and the stopper 305 is made to pass over the lower end 504 by the stronger rotating force. Therefore, the lower end 504 is placed between the stop protrusion 304 and the stopper 305.

In the above state, the cam 200 is linearly and axially moved downwards along the thread 306 due to the rotation of the middle joint 300, so that the cartridge that is being in contact with the lower end of the cam 200 is thrust in a direction toward the cartridge ejecting hole 401, thus being ejected from the cartridge ejecting hole.

Here, both the stopper 305 and the stop protrusion 304 of the middle joint 300 are engaged with the lower end 504 of the upper barrel 500 in such a way that the both the stopper 305 and the stop protrusion 304 are fixed, so that the ejected cartridge can be retained in the ejected state.

As the cam 200 is axially and linearly moved downwards, the clip 600 is further retracted into the clip receiving opening 204 of the cam 200, so that the clip 600 can be fully retracted in such a way that the outermost surface of the clip 600 is on an even level with the outer circumferential surface of the upper barrel 500.

When the upper barrel 500 is rotated in the direction opposed to in a state in which the cartridge has being in the ejected state, the stopper 305 of the middle joint 300 passes over the lower end 504 of the upper barrel 500 and the cartridge is retracted into the lower barrel due to the restoring force of the spring acting on the cartridge.

In other words, the cartridge is retracted into the lower barrel 400 through the cartridge ejecting hole 401 and the cam 200 is axially moved upwards in response to the retracted motion of the cartridge.

As the cam 200 is axially moved upwards, the middle joint 300 is rotated. Further, due to the upward movement of the cam 200, the clip 600 engaged with the cam 200 slides under the guide of both the inclined grooves 602 and the guide line groove 601, thus being ejected out of the upper barrel 500.

When the guide protrusion 202 of the cam 200 comes into contact with the end of the thread 306 formed in the middle joint 300 during the rotation of the middle joint 300, the guide protrusion 202 of the cam 200 cannot be further moved along the thread 306 so that the rotation of the middle joint 300 is stopped. In the above state, the cartridge is in a fully retracted state in the upper barrel 500 and is retained in a biased state relative to the end of the cam 200 by the restoring force of the spring.

What is claimed is:

1. A writing implement with a retractable clip, comprising:
a lower barrel (400) retractably receiving a spring-biased cartridge therein;
a middle joint (300) fastened at a second end thereof to the lower barrel (400) by a screw-type fastening;
a cam (200) having a guide protrusion (202) at an end thereof so as to be rotated and axially moved along a thread (306) formed on an inner surface of the middle joint (300);
an upper barrel (500) receiving the cam (200) therein and rotatably coupled at a first end thereof to the middle joint (300); and
a clip (600) ejected from and retracted into both the upper barrel (500) and the cam (200).

2. The writing implement with a retractable clip as set forth in claim 1, wherein, when the lower barrel (400) is rotated in a state in which the cartridge is retracted into the lower barrel (400) and the clip (600) is ejected from both the upper barrel (500) and the cam (200), the middle joint (300) is rotated along with the lower barrel (400) and the guide protrusion (202) of the cam (200) engaged with the thread (306) of the middle joint (300) moves downwards along the thread (306) by the rotation of the middle joint (300) so that the clip (600) engaged with the cam (200) slides to be retracted into the cam (200).

3. The writing implement with a retractable clip as set forth in claim 1, wherein the lower barrel (400) comprises:
a thread (402) formed on an inner surface of a first end of the lower barrel so that the middle joint (300) can be fastened to the lower barrel; and
a cartridge ejecting hole (401) formed in a second end of the lower barrel such that the cartridge can be ejected and retracted through the cartridge ejecting hole.

4. The writing implement with a retractable clip as set forth in claim 1, wherein the middle joint (300) comprises:
a lower barrel fastening thread (301) having a size corresponding to a diameter of the lower barrel (400) so as to be inserted into a first end of the lower barrel (400), the lower barrel fastening thread being formed on an outer surface of a lower part of the middle joint and fastened to an inner thread (402) of the lower barrel (400);
an upper barrel fastening groove (303) having an annular shape formed in the middle joint at a location spaced apart from the lower barrel fastening thread (301) by a predetermined distance, and engaged with an annular protrusion (507) of the upper barrel (500) such that the upper barrel (500) can be rotatably fastened to the groove (303);
a stop protrusion (304) axially protruding from an annular upper end surface (309) of the middle joint in such a way that the stop protrusion extends from inner and outer surfaces of the middle joint;
a stopper (305) axially protruding from the annular upper end surface (309) in such a way that the stopper extends from the inner surface of the middle joint and has a thickness smaller than a thickness of the stop protrusion (304); and
the thread (306) formed on the inner surface of the middle joint so as to be engaged with the guide protrusion (202) of the cam (200) in such a way that the guide protrusion can move along the thread (306).

5. The writing implement with a retractable clip as set forth in claim 1, wherein the cam (200) comprises:
a clip receiving opening (204) formed in an upper portion of the cam and receiving the clip (600) therein;
a plurality of inclined rails (203) formed on opposite inner surfaces of the clip receiving opening (204) and engaged with respective inclined grooves (602) of the clip (600); and
an upper barrel bar seat (209) having a cylindrical shape, with L-shaped cutouts formed in opposite sides of a circumferential surface of the upper barrel bar seat in such a way that the upper barrel (500) can be stopped by the cutouts so that, even when the middle joint (300) is rotated, the cam (200) can be prevented from rotating.

6. The writing implement with a retractable clip as set forth in claim 1, wherein the upper barrel (500) comprises:
a clip ejecting opening (505) having a long elliptical shape formed in a side surface of the upper barrel and allowing the clip (600) to be ejected from and retracted into the upper barrel;
a projection (502) formed in an upper portion of the clip ejecting opening (505) and engaged with a guide line groove (601) of the clip (600);
a middle joint fastening protrusion (507) having an annular shape formed on an inner surface of a lower part of the upper barrel and rotatably engaged with the middle joint (300);
a step (506) formed in a portion of the upper barrel spaced apart from the middle joint fastening protrusion (507) by a predetermined distance and providing a space for allowing both a stopper (305) and a stop protrusion (304) of the middle joint (300) to move; and
a pair of cam locking bars (503) axially formed in a sidewall of the upper barrel.

7. The writing implement with a retractable clip as set forth in claim 1, wherein the upper barrel (500) is provided with an anti-rolling protrusion (501) on a predetermined portion of an outer circumferential surface thereof.

8. The writing implement with a retractable clip as set forth in claim 1, wherein the clip (600) comprises:
a linear guide line groove (601) formed in an upper portion of a side surface of the clip in such a way that the guide line groove extends in a direction perpendicular to a cartridge moving direction; and
a plurality of inclined grooves (602) formed in opposite side surfaces of the clip at locations beneath and spaced apart from the guide line groove (601) by a predetermined distance and engaged with respective inclined rails (203) of the cam (200).
